(19) United States
(12) Patent Application Publication
(10) Pub. No.: US 2008/0205853 A1
(43) Pub. Date: Aug. 28, 2008

(54) Method of Monitoring the Control of Image Representations, Particularly from Safety-relevant Raw Data

(75) Inventors: Rolf Schroder, Budingen (DE); Olaf Kammer, Frankfurt (DE)

Correspondence Address: LERNER GREENBERG STEMER LLP, P O BOX 2480, HOLLYWOOD, FL, 33022-2480, US

(73) Assignee: DIEHL AEROSPACE GMBH, Uberlingen (DE)

(21) Appl. No.: 12/119,101

(22) Filed: May 12, 2008

Related U.S. Application Data
(63) Continuation of application No. PCT/EP2006/010686, filed on Nov. 8, 2006.

(30) Foreign Application Priority Data
Nov. 12, 2005 (DE) 10 2005 054 077.5
Apr. 13, 2006 (DE) 10 2006 017 422.4

(51) Int. Cl. H04N 7/64

(52) U.S. Cl. 386/113; 386/E09.006

(57) ABSTRACT

In order to check the operation of graphics generation carried out with safety-relevant raw data, in particular sensor data, for instance by geometric transformation and image filtering, test vectors are also processed in addition to the preprocessed raw data. The resulting video data are compared with the expected values in order to infer therefrom possible malfunctions. This eliminates complex back calculation of the video data for comparison with the graphics instructions or raw data on which the video data is based.

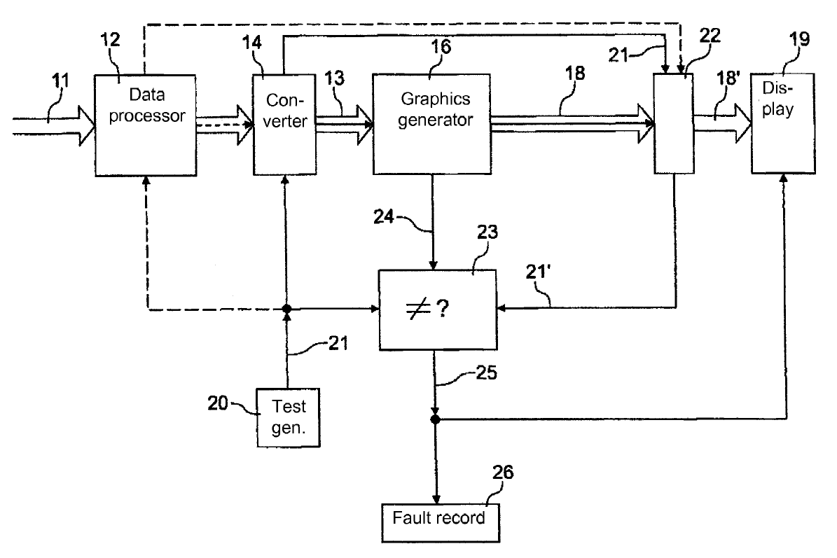

### CROSS-REFERENCE TO RELATED APPLICATIONS

This is a continuing application, under 35 U.S.C. § 120, of copending international application PCT/EP2006/010686, filed Nov. 8, 2006, which designated the United States; this application also claims the priority, under 35 U.S.C. § 119, of German patent applications DE 10 2005 054 077.5, filed Nov. 12, 2005, and DE 10 2006 017 422.4, filed Apr. 13, 2006; the prior applications are herewith incorporated by reference in their entirety.

### BACKGROUND OF THE INVENTION

### Field of the Invention

The present invention relates to a method for monitoring the control of visual representations on a screen with video data obtained from graphics instructions or raw data by graphics generation, by comparing source information with the video data obtained by the graphics generation,

Such a method is described in U.S. Pat. No. 7,012,553 B2 and in international publication WO 02/103292 A1 in the context of a flight guidance display which is used for on-screen display of sensor data which in particular is safety-relevant or otherwise functionally critical and which controls the graphics generation after their preprocessing for signal-processing purposes to form graphics instructions. By way of example, such graphics generation of the video data from the graphics instruction for the current imaging extends to geometric transformations, for example transformations between different coordinate systems, and image filtering, for example in the form of interpolation processing of the video signal sequence to smooth the image elements, which are to be finally displayed visually, and their changes in successive images. The graphics generation is thus very complex and the errors are correspondingly critical. To ensure that the video data resulting from this is not corrupted, specific graphics instructions are compared with the result of the graphics generation to see whether the original graphics instruction is still contained in the video signal. For this purpose, the graphics generation must be reversed computationally. This requires extraordinarily high level of complexity for computer architectures, which are expensive since they work particularly quickly, because the individually selected video data for checking should additionally control the screen in parallel. This complexity of the checking mechanisms inevitably leads to a certain susceptibility to faults which can subsequently simulate non-existent malfunctions in the creation of the video data.

Thus, the issue here is not to check the screen as to whether all its coordinate points (pixels) are still functional; instead, the question is whether its graphical displays, generated from the video data, still correspond to the information which is contained in the graphics instructions, and should in fact be displayed.

### BRIEF SUMMARY OF THE INVENTION

It is accordingly an object of the invention to provide a method for monitoring the control of image representations, in particular for safety and security relevant raw data, which overcomes the above-mentioned disadvantages of the heretofore-known devices and methods of this general type and which implements a less complex, and thus less error-prone, process for checking the generation of video data, which requires less computing power for this simple checking function.

With the foregoing and other objects in view there is provided, in accordance with the invention, a video display method, which comprises:

subjecting graphics instructions or raw data to a graphics generation for generating video data;

generating test vectors and feeding the test vectors into the graphics generation in addition to the graphics instructions;

displaying the video data on a screen and monitoring a control of the visual representations on the screen by comparing the test vectors with the video data obtained in the graphics generation.

In other words, the objects of the invention are achieved in that actual, arriving raw data, such as sensor data, which at this time are being preprocessed into graphics instructions, are not used for checking the graphics generation from graphics instructions. Instead of this, test vectors, generated specifically for this purpose, are used. Comparison of the video data, as expected when considering the known rules of graphics generation, with the fed-in test vectors results in an error message in the case of malfunctions, which error message can, for example, initiate switching to a different type of representation or immediately switch to a reserve system for graphics generation.

The video data generated from the test vectors expediently does not control pixels in the image representation, but areas of the screen which are not currently used for image representation. For instance, said data occur in a quadrant of the display which currently displays no information or preferably also at the edge below the display area frame, so as not to burden the current image representation with mere test inserts. It is even preferable to filter out this video data, which is relevant only for testing, from the result of the graphics generation and thus completely separate it from the video data for controlling the screen. This is possible without major additional complexity by means of dedicated logic upstream of the screen control due to the known laws governing generation of the test vectors.

There is a considerable shortage of conventional systems optimized specifically for extreme safety requirements, due to the rapidly increasing demands both financially and technically (regarding their availability); this is overcome by implementing the checking functions designed according to the invention. Accordingly, it is possible to satisfy the continually increasing requirement for the reliability of the graphical representation of complex circumstances, for instance in the cockpit of an airplane, using comparatively cheap standard modules for commercial data processing. Even if the internal architecture of those modules is often not well-known, their functions are well documented, which is quite sufficient for the described checking functions.

In a refinement of this inventive solution, test vectors can be fed into the data preprocessing with the raw data instead of, or in addition to, the graphics instructions before the graphics generation. This upstream data processing for converting the raw data to graphics instructions is also very complex. For instance, it comprises limiting the useful spectrum of the raw data and the sampling thereof for the purpose of digitizing, taking into account band limiting to comply with the sampling theorem, further integral or differential filtering to influence the signal dynamics, or nonlinear amplification and scaling to avoid data loss due to noise and as a result of overdriving. By comparison of the prescribed test vectors with the expected, resultant video data, the proper operation of the data preprocessing can also be checked at the same time.

Pseudo-stochastic signal sequences of defined lengths, which can be generated in a technically simple manner and can be reproduced unambiguously, for example by a feedback shift registers or correspondingly small processor programs, are expediently chosen in this case as test vectors. Hence, these test vectors are subsequently subject to the same complex signal preprocessing as the sensor data prior to geometric transformation and image filtering as part of the graphics generation. The test vectors' stochastic process is not influenced by the signal processing, so the test vectors can be directly compared to the resultant video data by means of cross-correlation. This avoids the otherwise very major additional data processing-technical complexity just for fast back-calculation of the video data to yield its source information: the intensity of the convolution product shows directly whether malfunctions may have occurred during the signal processing. In this case, it is expedient to generate differently designed test vectors, which are optimally matched to specific critical signal processing procedures, in order to be able to obtain particularly significant correlation results from this.

In summary, it can thus be established that the technically and temporally very complex back-calculation of video data for comparison with its source information, which was common until now, can be dispensed with according to the invention if—in order to check at least the operation of the graphics generation, but optionally also its preprocessing of raw data—test vectors generated specially for this purpose are processed in the same path and in addition to the graphics instructions or the raw data and are compared with the video data resulting therefrom in order to recognize possible malfunctions.

Other features which are considered as characteristic for the invention are set forth in the appended claims.

Although the invention is illustrated and described herein as embodied in method for monitoring the control of image representations, particularly from safety-relevant raw data, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawing.

### BRIEF DESCRIPTION OF DRAWING

The sole FIGURE of the drawing is an abstract, basic block diagram illustrating the feeding-in and checking of test vectors for continuous monitoring of the current video image obtained from the raw data.

### DETAILED DESCRIPTION OF THE INVENTION

Referring now to the FIGURE of the drawing in detail, the raw data in the form of sensor data 11 from a multiplicity of sensors for monitoring operationally or safety-critical conditions are preprocessed in a data processor 12 to obtain a block of graphics instructions 13 at the output of a converter 14. The vectors of these graphics instructions 13 are fed to a graphics generator 16, which is available at low cost when using the industry standard (such as Open Graphic Language). The video image based on the current sensor data 11 is available as a vector of video data 18 at the output of the generator 16. The visual representation on a screen 19 is driven by the video data 18 in this way.

A test generator 20 supplies an externally predeterminable test vector 21 which is superposed on the sensor-dependent graphics instructions 13 in the converter 14. As a result of this, both are signal processed in the same way in the graphics generator 16, and the correspondingly processed test vector 21 is contained in the video data 18 of the video image. Adapted, and thus different, test vectors 21 are expediently assigned to the numerous, very different functions of the graphics generation.

However, information from the test vector 21 should not be displayed on the screen 19, so as not to interfere with the actual visual presentation of interest. For this reason, the test vectors 21 can for example be placed on edge areas of the screen 19 which are not used for the display and are sometimes covered by the display area. (However, the functional monitoring is optimal when test vectors 21 are distributed over the entire video image at the output of the graphics generator 16 and correspondingly over the entire screen 19.) The current test vector is separated from the video data 18 before the control of the screen 19 so as not to interfere with the visual representation on the screen 19. For this purpose, so-called dedicated or association logic 22 is provided for the video data 18 prior to the control of the screen 19. This is designed to separate out the test vectors 21′ contained in the video data 18 by knowing the currently fed-in test vector 21, so that the video data 18′, from which the simple test vectors 21′ have been removed, are applied to the screen 19, that is to say it presents images only based on the sensor data 11.

The test vector 21′, which has been graphically processed like the video data 18 but separated therefrom, is compared with the originally fed-in test vector 21 in a comparator 23, taking into account the current processing preset 24 from the graphics generator 16. If there is a match in principle, no malfunction has occurred during the graphics processing of the sensor data 11, and the cleansed video data 18′ are correctly displayed on the screen 19. Otherwise, the comparator 23 outputs a fault message 25 which, for instance, results in a warning indication on the screen 19 or directly switching to a reserve system for video processing of sensor data 11 and which additionally is transferred to a fault record 26.

The dashed lines in the block diagram indicate the option of (additionally or only) feeding the test vector 21 into the signal flow earlier, upstream of the graphics generator 16—into the data processor 12 to be precise—for pre-processing of the supplied sensor data 11 for signal-processing purposes. If the laws governing this preprocessing are taken into account in the operation of the comparator 23, the monitoring is thus not limited to image generation, but also includes the preprocessing of the sensor data 11 delivered to the image generation process, since the test vectors 21 each pass through the same as that in the graphics generator 16 and the data processor 12 processing path for the preprocessing of the arriving critical sensor data 11; that is to say, they are subject to the same error influences.

1. A video display method, which comprises:
subjecting graphics instructions or raw data to graphics generation and generating therefrom video data;
generating test vectors and feeding the test vectors into the graphics generation in addition to the graphics instructions;
displaying the video data on a screen and monitoring a control of the visual representations on the screen by comparing the test vectors with the video data obtained in the graphics generation.

2. The method according to claim 1, which comprises assigning mutually different test vectors to mutually different functions of the graphics generation.

3. The method according to claim 1, which comprises separating the video data resulting from the test vectors prior to the screen control and feeding same to the comparison process.

4. The method according to claim 1, which comprises feeding the test vectors into data preprocessing of the sensor data prior to the graphics generation.

5. The method according to claim 1, which comprises providing test vectors containing pseudo-stochastic signal sequences and cross-correlating the test vectors with the resulting video signals.

6. The method according to claim 1, wherein the raw data are safety-relevant data.

7. The method according to claim 6, wherein the raw data are sensor data.
